(19) United States
(12) Patent Application Publication
(10) Pub. No.: US 2026/0017593 A1
(43) Pub. Date: Jan. 15, 2026

(54) Dynamic Asset Relationship Mapping and Risk Propagation Analysis Using Degree of Connections

(71) Applicant: Ordr Inc., Santa Clara, CA (US)

(72) Inventors: Sakthi Dasan Sekar, Chennai (IN); Gnanaprakasam Pandian, Cupertino, CA (US); Deepak Cherian, Newark, CA (US); Gowri Sunder Ravi, Mountain View, CA (US)

(73) Assignee: Ordr Inc., Santa Clara, CA (US)

(21) Appl. No.: 18/770,095

(22) Filed: Jul. 11, 2024

(51) Int. Cl. G06Q 10/0635

(52) U.S. Cl. CPC G06Q 10/0635

(57) ABSTRACT

A system generates a graph of assets in a network. The system defines connections between assets within the graph. The system identifies a risk event with an associated risk severity. The system determines a number of connections to traverse for generating a risk analysis pathway through the graph of assets in the network based on the associated risk severity associated with the risk event. The system generates a recommendation to address the identified risk.

### TECHNICAL FIELD

The present disclosure relates to risk analysis for computer networks.

### BACKGROUND

Network discovery systems employ automated scanning techniques to detect and map enterprise environments. Such systems remotely probe network infrastructure to identify components and connected devices. Network administrators use customization features to generate tailored maps and diagrams for implementation planning. Automation reduces manual effort compared to legacy mapping solutions lacking discovery capabilities. Comprehensive component support allows discovery of diverse network elements. Mapping systems detect and catalog components from varied software providers and hardware manufacturers. Discovery processes determine component locations and roles within the broader network context.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for dynamic asset relationship mapping and risk propagation analysis in accordance with one or more embodiments;

FIG. 2 illustrates an example set of operations for risk propagation analysis that determines a number of connections to traverse for generating a risk analysis pathway in accordance with one or more embodiments;

FIG. 3A illustrates an exemplary network graph in accordance with one or more embodiments;

FIG. 3B illustrates an exemplary network graph showing a risk analysis pathway in accordance with one or more embodiments;

FIG. 3C illustrates an exemplary network graph showing a shortened risk analysis pathway that terminates at an asset with a security profile that meets a pathway termination criteria in accordance with one or more embodiments;

FIG. 4 illustrates a block diagram of a system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present embodiment.
1. GENERAL OVERVIEW
2. RISK PROPAGATION ANALYSIS SYSTEM
3. DETERMINING NUMBER OF CONNECTIONS TO TRAVERSE FOR GENERATING A RISK ANALYSIS PATHWAY
4. NETWORK GRAPH EXAMPLES
5. PRACTICAL APPLICATIONS, ADVANTAGES, & IMPROVEMENTS
6. MISCELLANEOUS; EXTENSIONS
7. HARDWARE OVERVIEW

### 1. General Overview

One or more embodiments compute an extent of traversal from a target asset, that has been impacted or potentially impacted by a risk event, to other assets for risk propagation analysis. The risk propagation system uses a generated asset graph in a network to determine additional assets in the network that are at risk due to a risk event at the target asset. The risk propagation analysis system determines a number of connections to traverse for generating a risk analysis pathway through an asset graph in the network. The number of connections are determined based on information concerning the asset graph in the network, such as the relationships between assets, the severity of the risk event, the type of risk event, the importance of the assets, and the security profile of the assets.

Once a number of connections is determined, the system traverses assets in the asset graph from the target asset until the number of connections have been traversed to create different risk analysis pathways. When a traversed asset has multiple connections (not including the connection from which the traversed asset was reached), multiple respective risk analysis pathways are created. Risk analysis pathways are continued until the number of connections from the target asset has been reached.

In an embodiment, the system determines a traversal score for traversing the asset graph instead of a number of connections. Risk analysis pathways are extended based on the traversal score. The system assigns a link score (also referred to herein as a “weight”) to the links between pairs of assets. When a link is traversed on any particular risk analysis pathway, the traversal score (being maintained for that particular risk analysis pathway) is reduced by the link score corresponding to the link. When the remaining traversal score for a risk analysis pathway is zero or less than the link score for a next link to be traversed, the system terminates that risk analysis pathway.

In some circumstances, the system may stop the traversal in a particular direction before the number of connections have been traversed or before the traversal score reaches zero. The system may stop the traversal in a particular direction when an asset is reached that has already been traversed (e.g., via another risk analysis pathway). The system may stop the traversal in a particular direction when the characteristics of the asset meet a traversal termination criteria. For example, the system may reach a secure device that does not propagate malicious data, processes, or applications. Traversing beyond this secure device to other connected devices is not necessary because the other connected devices are determined to not be at risk.

One or more embodiments generate a recommendation for particular assets to address the identified risk event. The impact of a risk event is likely reduced at an asset that is further away from a target asset than an asset that is closer to the target asset. Accordingly, the system may generate recommendations that include a more thorough risk analysis and/or impact evaluation for an asset that is closer to the target asset than another asset that is further away from the target asset. Similarly, the system may generate recommendations that include more substantial remediation actions for an asset that is closer to the target asset than another asset that is further away from the target asset.

One or more embodiments described in this Specification and/or recited in the claims may not be included in this General Overview section.

### 2. Risk Propagation Analysis System

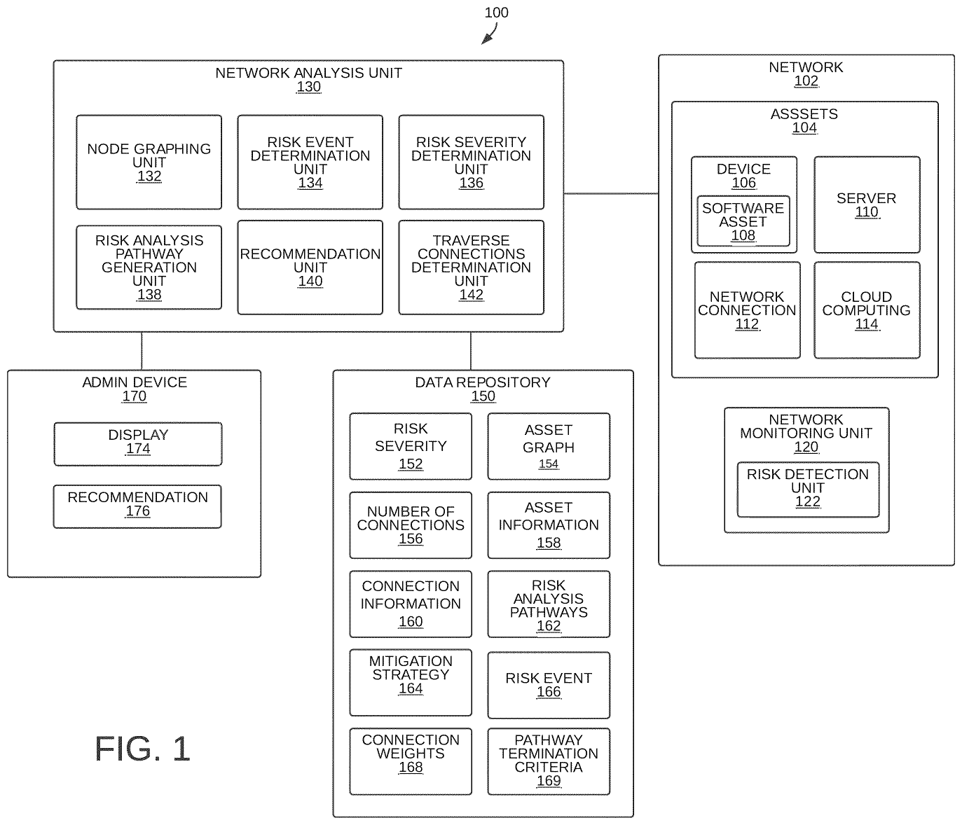

FIG. 1 illustrates a system for dynamic asset relationship mapping and risk propagation analysis in accordance with one or more embodiments. The risk propagation analysis system 100 is a system designed to determine a number of connections to traverse for generating a risk analysis pathway through the asset graph in the network and generate a recommendation to address the identified risk event.

As illustrated in FIG. 1, the system 100 includes a network monitoring unit 120, risk detection unit 122, network analysis unit 130, node graphing unit 132, risk event determination unit 134, risk severity determination unit 136, risk analysis pathway generation unit 138, recommendation unit 140, traverse connections determination unit 142, and data repository 150. In one or more embodiments, the system 100 may include more components or fewer components than the components illustrated in FIG. 1. The components illustrated in FIG. 1 may be local to or remote from each other. The components illustrated in FIG. 1 may be implemented in software and/or hardware. Components may be distributed over multiple applications and/or machines. Multiple components may be combined into one application and/or machine. Operations described with respect to one component may instead be performed by another component.

In accordance with an embodiment, network 102 connects multiple computing devices to facilitate communication and resource sharing. Network 102 comprises various hardware components, including routers, switches, and infrastructure. Computing devices on the network exchange data packets through defined protocols, enabling information transfer.

In accordance with an embodiment, network 102 includes assets 104. In the example of FIG. 1, exemplary assets 104 include device 106, software asset 108, server 110, network connection 112, and cloud computing asset 114. As described below, network 102 may include additional asset types.

In accordance with an embodiment, device 106 operates as a node within a computer network. Device 106 connects to other network devices through wired or wireless interfaces. The device processes and transmits data packets according to network protocols. Components of device 106 include a processor, memory, and a network interface card. In one example, device 106 is any type of electronic computing apparatus, such as a phone, laptop, or desktop.

In accordance with an embodiment, software asset 108 is any type of software at device 106. Application software performs specific tasks, enabling users to accomplish various functions within the network. Database management systems store, retrieve, and manage data, supporting efficient data operations and ensuring data integrity. Virtualization software creates virtual environments, optimizing resource utilization and enabling flexible management of computing resources. Security software, including antivirus programs and firewalls, protects the network from threats and vulnerabilities, ensuring the integrity and availability of data and applications.

In accordance with an embodiment, server 110 provides computing resources and services to network 102. Physical servers host critical applications and store data, supporting various operational needs and ensuring high availability. Virtual servers offer scalable computing environments, allowing flexible resource allocation and efficient utilization of hardware. Web servers handle HTTP requests and deliver content to users, ensuring timely access to websites and online services. Application servers run software applications, providing necessary services to other network components and users. Database servers store and manage structured data, enabling efficient retrieval and manipulation of information. File servers store and share files, facilitating collaboration and data access across the network.

In accordance with an embodiment, network connection 112 connects to external networks such as the Internet. In one example, network connection 112 is a router, gateway, or wireless access point. Routers direct data packets to appropriate destinations based on network addresses. Gateways translate data between networks using different protocols. Wireless access points broadcast wireless signals to create a coverage area for device connectivity.

In accordance with an embodiment, cloud computing asset 114 operates as a virtualized resource accessible through network connections. Cloud computing asset 114 resides on remote servers maintained by service providers. Cloud computing asset 114 delivers computing power, storage capacity, or software services on demand. Users access cloud computing asset 114 via web interfaces or application programming interfaces. Cloud computing asset 114 scales dynamically to accommodate varying workloads. Cloud computing asset 114 implements multi-tenancy to serve multiple users simultaneously. Cloud computing asset 114 offers geographically distributed resources for improved performance and disaster recovery.

In accordance with an embodiment, assets 104 further includes additional types of assets. Endpoint assets include workstations, laptops, and mobile devices utilized by users for daily operations. IoT devices and point-of-sale systems extend network connectivity to specialized hardware. Network assets form the backbone of communication infrastructure, encompassing routers, switches, and firewalls. Load balancers distribute traffic across resources, while VPN gateways secure remote connections. Wireless access points enable mobile connectivity within physical spaces. Server assets provide computational power and services to network users. Physical servers occupy data center racks, while virtual servers operate on shared hardware. Web servers host websites and web applications; application servers run business logic; and database servers store structured data. File servers centralize document storage and sharing. Cloud assets extend network capabilities beyond on-premise infrastructure. Compute instances offer scalable processing power, while cloud storage provides flexible data repositories. Cloud databases offer managed database services, and cloud-based applications deliver software as a service. Software assets run on hardware throughout the network. Operating systems manage device resources and provide user interfaces. Application software enables specific tasks and workflows. Database management systems organize and retrieve data efficiently. Virtualization software creates abstract computing environments. Security software protects against threats and monitors network activity. Data assets represent valuable information stored and processed within the network. Databases contain structured records, while file shares house documents and unstructured data. Backups and archives preserve historical data. Intellectual property and customer information require stringent protection measures. Identity and access management assets control user authentication and authorization. User accounts and credentials enable individual access to resources. Directory services centralize user information and group memberships. Identity providers authenticate users across multiple systems. Access control systems enforce granular permissions based on user roles and attributes. Security infrastructure assets bolster network defenses. Security information and event management systems aggregate and analyze security logs. Security orchestration platforms automate incident response workflows. Vulnerability management systems identify and prioritize weaknesses. Patch management systems distribute software updates to maintain system security. Human assets include users, such as employees and contractors. Physical security assets safeguard network infrastructure and data centers. Access control systems restrict entry to sensitive areas. Surveillance systems monitor physical spaces for unauthorized activity. Environmental controls protect hardware from physical threats and maintain optimal operating conditions.

In accordance with an embodiment, network monitoring unit 120 observes and analyzes network activity. Network monitoring unit 120 collects data on performance metrics, identifying potential issues and anomalies. The system uses monitoring data to optimize network operations and maintain a secure environment. Network monitoring unit 120 observes and analyzes network traffic and infrastructure components. Network monitoring unit 120 collects data from various network devices through protocols such as SNMP. Network monitoring unit 120 processes collected information to generate performance metrics and status reports. Network administrators configure alerts based on predefined thresholds or anomalies.

In accordance with an embodiment, network monitoring unit 120 includes risk detection unit 122 to identify potential threats and vulnerabilities within the network such as risk event 166. The system scans for signs of malicious activity or weaknesses, assessing the risk level of detected threats.

In accordance with an embodiment, network analysis unit 130 examines the network 102 structure and performance. Network analysis unit 130 produces a graph of a network, analyses network 102 for security risks, and produces recommendations concerning the security risks. As described below, network analysis unit 130 includes a number of units including node graphing unit 132, risk event determination unit 134, risk severity determination unit 136, risk analysis pathway generation unit 138, recommendation unit 140, and traverse connections determination unit 142.

In accordance with an embodiment, node graphing unit 132 determines assets 104 and asset connections to produce asset graph 154. Node graphing unit 132 obtains asset information 158, such as security profiles, connection information 160, and connection weights 168 concerning assets 104 of network 102. Node graphing unit 132 analyzes input data to identify individual assets within a network 102. Node graphing unit 132 determines asset connections based on relationships or interactions between identified assets. Node graphing unit 132 generates a graph structure to represent assets 104 as nodes and connections as edges. The resulting asset graph 154 provides a visual representation of the asset network topology.

In accordance with an embodiment, risk event determination unit 134 identifies and classifies risk events in network 102 in conjunction with risk detection unit 122. Risk event determination unit 134 analyzes network traffic patterns to detect anomalies indicative of potential security threats. In one example, risk event determination unit 134 applies machine learning algorithms to classify detected anomalies into specific risk categories. Risk event determination unit 134 analyzes network traffic patterns to detect anomalies. Risk event determination unit 134 scans for known attack signatures utilizing intrusion detection mechanisms. In one example, risk event determination unit 134 logs and flags suspicious connection attempts. In one example, risk event determination unit 134 uses threat intelligence feeds to identify emerging threats and vulnerabilities relevant to network infrastructure. Risk event determination unit 134 probes network devices and applications to discover unpatched vulnerabilities or misconfigurations. Risk event determination unit 134 tracks normal user activity patterns and flags deviations indicative of insider threats or compromised accounts. Risk event determination unit 134 maps potential attack vectors based on network architecture and asset criticality.

In accordance with an embodiment, network analysis unit 130 uses a risk severity determination unit 136 to determine risk severity 152. Risk severity determination unit 136 evaluates detected risk events to assess their potential impact on network operations. Risk severity determination unit 136 assigns severity scores to identified threats based on predefined criteria. Risk severity determination unit 136 considers various factors, such as asset criticality, vulnerability exploitability, and potential data exposure to assign severity scores. In one example, risk severity determination unit 136 uses historical incident data to refine severity calculations. Risk severity determination unit 136 generates prioritized risk reports for security teams to focus remediation efforts.

In accordance with an embodiment, traverse connections determination unit 142 uses connection weights 168 of the assets to determine the number of connections 156. Traverse connections determination unit 142 evaluates risk severity as a factor to determining the extent of potential risk propagation. Traverse connections determination unit 142 analyzes asset characteristics within identified pathways to refine connection calculations. Traverse connections determination unit 142 assigns weights to connections based on the criticality of linked assets and severity of the initial risk.

In accordance with an embodiment, risk analysis pathway generation unit 138 generates indications of risk analysis pathways 162 using the determined connections from traverse connections determination unit 142. Risk analysis pathway generation unit 138 incorporates connection data to show the most likely routes of risk transmission and thus possible vulnerability traversals in the network.

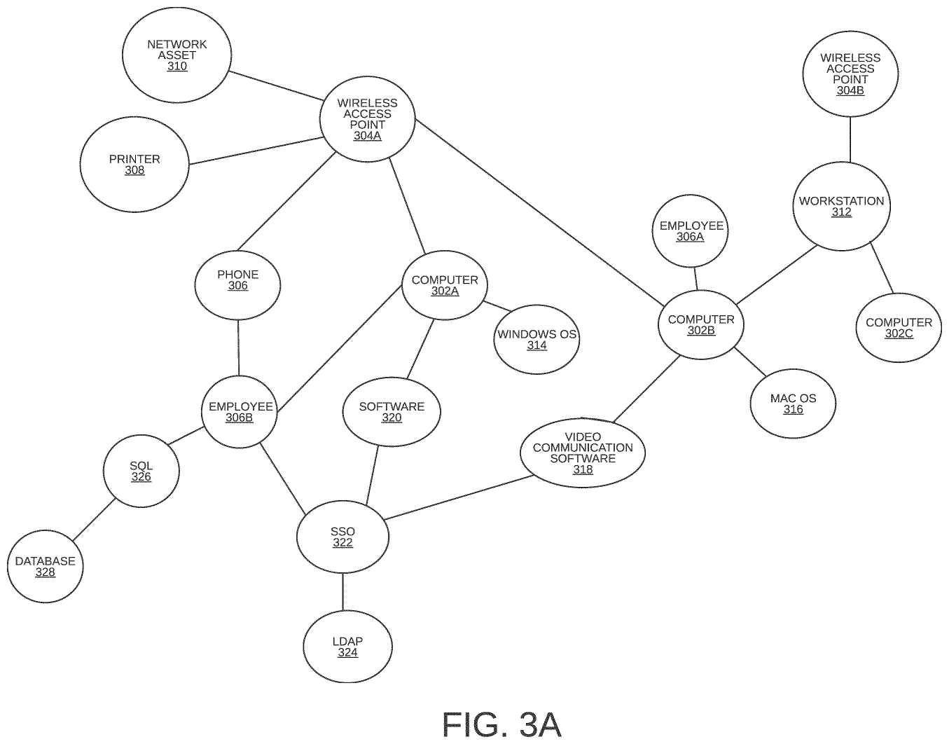

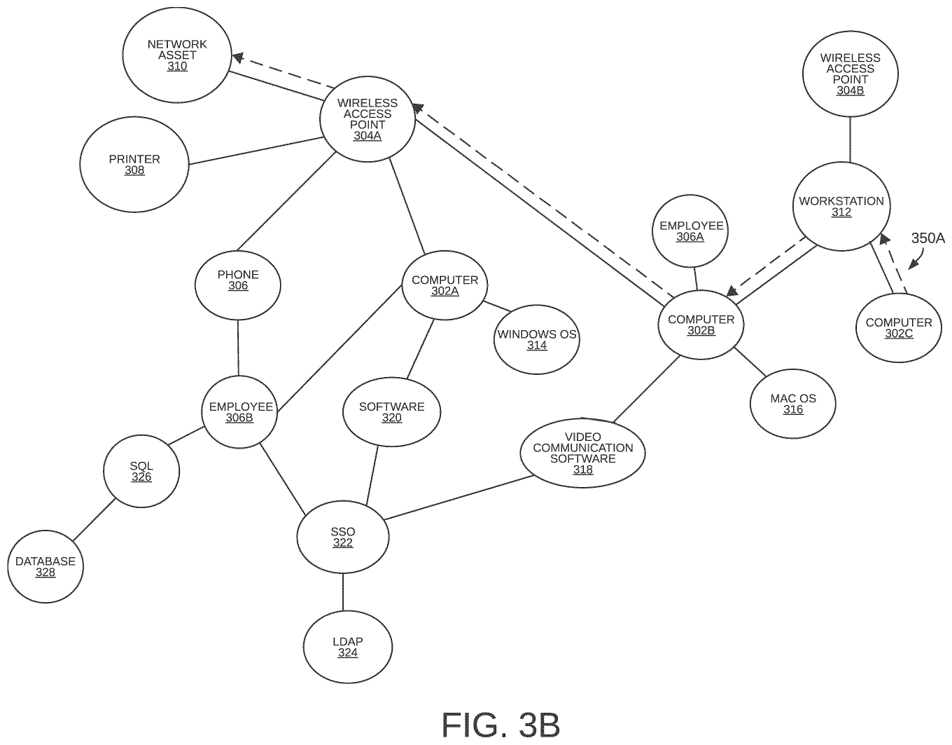

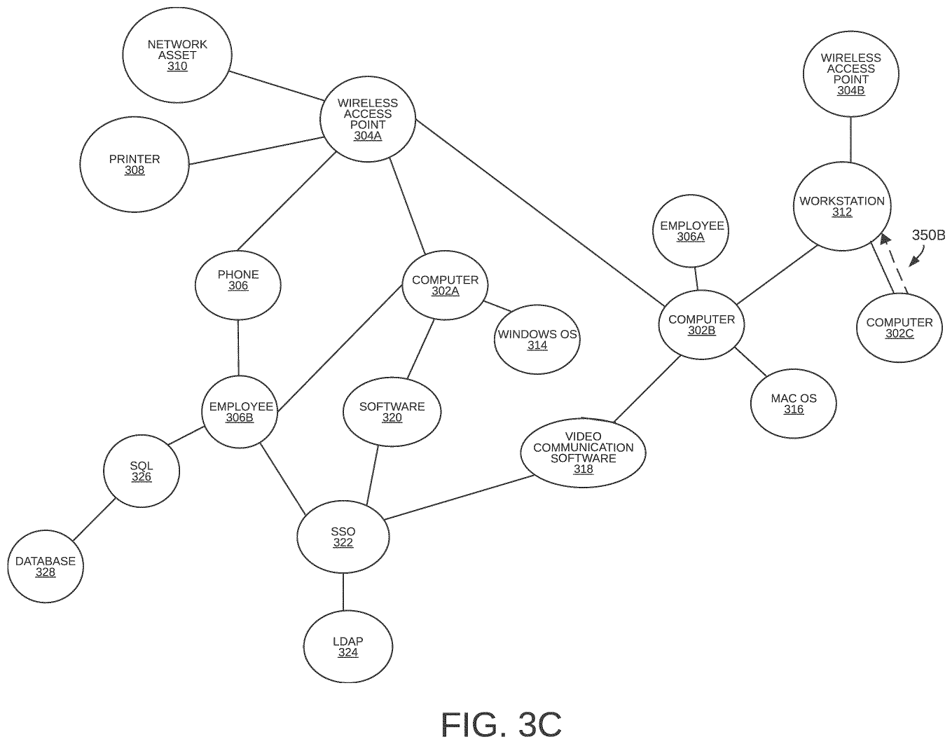

In accordance with an embodiment, network analysis unit 130 uses pathway termination criteria 169 to determine whether or not to terminate risk analysis pathways 162 due to a security profile of an asset. If an asset is sufficiently secure as indicated by the security profile, network analysis unit 130 terminates a risk analysis pathway at the asset. For example, the security profile for an asset is compared with pathway termination criteria 169. If the security profile meets the pathway termination criteria 169, the risk analysis pathway is terminated at the asset. An example of such a risk analysis pathway termination at a secure asset is described below with respect to FIG. 3C.

In accordance with an embodiment, recommendation unit 140 generates suggestions, such as mitigation strategy 164 and recommendation 176, for mitigating identified risks at assets in risk analysis pathways. Recommendation unit 140 analyzes risk severity and propagation data to prioritize mitigation efforts. Recommendation unit 140 personalizes suggestions to specific asset types and vulnerabilities within the network. Recommendation unit 140 considers the potential impact on network operations when proposing mitigation strategies. Recommendation unit 140 provides step-by-step action plans for implementing suggested security measures. Recommendation unit 140 adapts its recommendations to align with organizational risk tolerance and resource constraints. Recommendation unit 140 collaborates with other system components to ensure comprehensive risk mitigation across the entire network infrastructure.

In accordance with an embodiment, admin device 170 interfaces with network analysis unit 130. Admin device 170 uses display 174 to display asset graph 154 and recommendation 176 as well as other information such as mitigation strategy 164. Admin device 170 displays visual representations of risk analysis pathways to network administrators. Admin device 170 allows administrators to input custom risk thresholds and asset criticality values. Admin device 170 facilitates the implementation of recommended mitigation strategies across network assets. Admin device 170 enables administrators to initiate automated response protocols for specific risk scenarios.

In one or more embodiments, data repository 150 stores the data and configuration of system 100. Data repository 150 is any type of storage unit and/or device (e.g., a file system, database, collection of tables, or any other storage mechanism) for storing data. Furthermore, data repository 150 includes a single or multiple different storage units and/or devices. The multiple different storage units and/or devices may or may not be of the same type or located at the same physical site. Data repository 150 is implemented or executed on the same computing system or different computing system as system 100.

### 3. Determining Number of Connections to Traverse for Generating a Risk Analysis Pathway

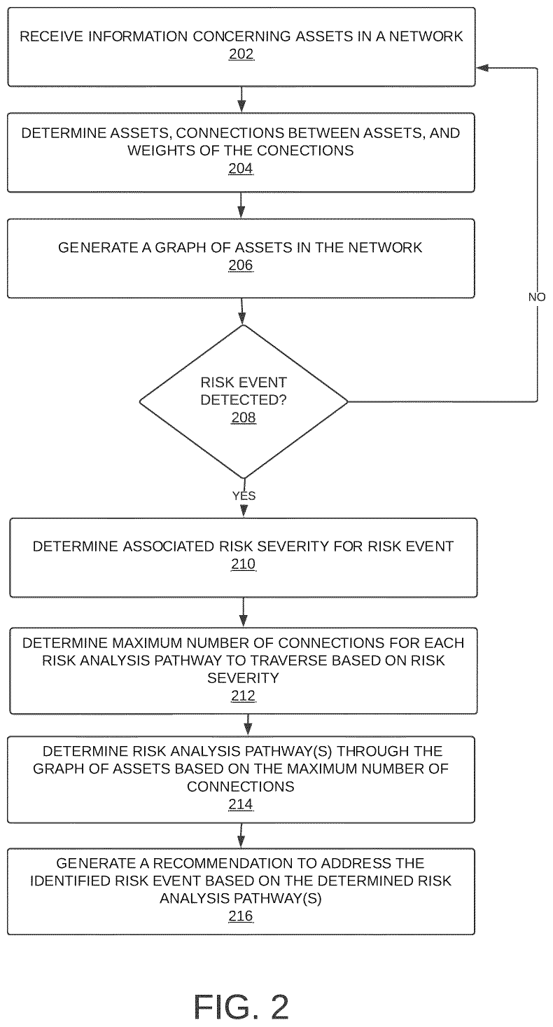

FIG. 2 illustrates an example set of operations for risk propagation analysis that determines a number of connections to traverse for generating a risk analysis pathway in accordance with one or more embodiments. Some of the example set of operations described below specifically describe a risk propagation analysis. However, a similar or modified set of operations may be executed for any risk propagation analysis. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system receives information concerning assets in a network (Operation 202). The system gathers data about assets including hardware devices, software applications, and data repositories within the network infrastructure. Asset information includes various details, such as device types, operating systems, installed software versions, and network configurations. The system collects asset data through automated discovery tools, manual input from administrators, and integration with existing asset management databases. Asset information encompasses physical attributes, logical relationships, and dependencies between network components. The system continuously updates asset information to maintain an accurate representation of the network environment. Asset data includes security-relevant information, such as patch levels, known vulnerabilities, and access control settings.

In an embodiment, the system determines assets, connections between assets, and weights of the connections (Operation 204). The system identifies individual network components and establishes their relationships within the infrastructure. Connection weights are assigned based on different factors, such as data flow volume, criticality of information exchanged, and potential impact of compromise. The system evaluates both direct and indirect connections between assets to create a comprehensive network topology. The system also produces a security profile for the assets based on the network information.

In an embodiment, the system generates an asset graph in the network (Operation 206). The graph representation visualizes the network structure, depicting assets as nodes and connections as edges. Asset attributes and connection weights are incorporated into the graph to provide a detailed view of the network ecosystem. The graph serves as a foundation for subsequent risk analysis and propagation modeling.

Weights between pairs of assets in the network are established based on interactions and dependencies. The system uses these weights to determine connection traversal limits for additional risk analysis pathways. As new assets join the network and new connections form, the system dynamically updates the asset graph. Graph generation involves monitoring communications between asset pairs and creating links based on observed interactions.

In an embodiment, the system determines if a risk event is detected (Operation 208). Risk detection mechanisms continuously monitor network traffic, system logs, and security events for anomalies or indicators of compromise. In an example, the system employs various detection techniques, including signature-based detection, behavioral analysis, and machine learning algorithms, to identify potential security threats.

In an embodiment, if a risk event is detected in operation 208, the system determines an associated risk severity for risk event (Operation 210). Risk severity assessment takes into account various factors, such as potential impact on business operations, data sensitivity, and likelihood of exploitation. The system assigns severity scores to detected risk events based on predefined criteria and contextual analysis. Severity determination informs prioritization of response efforts and resource allocation. If a risk event is not detected in operation 208, the system continues to monitor the network in operations 202, 204 and 206.

In an embodiment, the system determines maximum number of connections for risk analysis pathways to traverse based on risk severity (Operation 212). The maximum connection limit is dynamically adjusted according to the assessed severity of the risk event. Higher severity risks warrant more extensive pathway analysis, encompassing a broader range of potentially affected assets. The connection limit helps focus analysis on the most relevant propagation routes.

In one example, multiple risk analysis pathways commencing at a target asset corresponding to the risk event are determined that traverse the specified number of connections. When a second risk event with higher severity is identified, the system determines a greater number of connections to traverse, generating a more extensive set of recommendations.

In an embodiment, the system determines risk analysis pathway(s) through the asset graph based on the maximum number of connections (Operation 214). Pathways are traced from the initial risk source to connected assets, respecting the established connection limit. The system evaluates multiple potential propagation routes, considering factors, such as network segmentation and security controls, along paths. Risk analysis pathways highlight the potential spread of security threats across the network infrastructure.

In an embodiment, once a number of connections is determined, the system traverses assets in the asset graph from the target asset until the number of connections have been traversed to create different risk analysis pathways. When a traversed asset has multiple connections (not including the connection from which the traversed asset was reached), multiple respective risk analysis pathways are created. Risk analysis pathways are continued until the number of connections from the target asset has been reached.

In an embodiment, the system determines a traversal score budget for traversing the asset graph instead of a number of connections. Risk analysis pathways are extended based on the traversal score budget. The system assigns a link score (also referred to herein as a “weight”) to the links between pairs of assets. When a link is traversed on any particular risk analysis pathway, the traversal score (being maintained for that particular risk analysis pathway) is reduced by the link score corresponding to the link. When the remaining traversal score for a risk analysis pathway is zero or less than the link score for a next link to be traversed, the system terminates that risk analysis pathway.

In an embodiment, the traversal score budget is determined based on information concerning the asset graph in the network, such as the severity of the risk event, the type of risk event, the importance of the assets, and the security profile of the assets. Link scores between assets are based on information concerning the asset graph in the network, such as the likelihood that a risk event would transfer between the assets, and the type of the assets. The traversal score budget and link scores are calibrated with respect to each other. In one example, the traversal score budget and link scores may be determined using one or more machine learning units based on historical network information.

In an embodiment, the system generates a recommendation to address the identified risk event based on the determined risk analysis pathway(s) (Operation 216). Recommendations are tailored to mitigate risks at critical points along the identified propagation pathways. The system prioritizes actions that offer the greatest risk reduction across multiple potential attack vectors. Recommendations include mitigation strategies that the system implements to address risk events. In one example, recommendations include specific remediation steps, such as patching vulnerabilities, adjusting firewall rules, or implementing additional access controls.

In some circumstances, the system may stop the traversal in a particular direction before the number of connections have been traversed or before the traversal score reaches zero. The system may stop the traversal in a particular direction when an asset is reached that has already been traversed (e.g., via another risk analysis pathway). The system may stop the traversal in a particular direction when the characteristics of the asset meet a traversal termination criteria. For example, the system may reach a secure device that does not propagate malicious data, processes, or applications. Traversing beyond this secure device to other connected devices is not necessary because the other connected devices are determined to not be at risk.

One or more embodiments generate a recommendation for particular assets to address the identified risk event. The impact of a risk event is likely reduced at an asset that is further away from a target asset than an asset that is closer to the target asset. Accordingly, the system may generate recommendations that include a more thorough risk analysis and/or impact evaluation for an asset that is closer to the target asset than another asset that is further away from the target asset. Similarly, the system may generate recommendations that include more substantial remediation actions for an asset that is closer to the target asset than another asset that is further away from the target asset.

In an embodiment, the use of connection information allows the system to perform dynamic asset relationship mapping and risk propagation analysis. This approach enables organizations to manage and mitigate cybersecurity risks by understanding asset interdependencies and potential threat propagation pathways. Traditional asset management systems often statically categorize assets and connections, whereas the use of connection information allows the system to provide a nuanced understanding of asset relationships.

In an embodiment, the integrated risk propagation model uses mapped asset relationships to predict vulnerability and threat traversal through the asset network. Factors, such as connection type, asset criticality, and the nature of the vulnerability, are considered in this comprehensive risk assessment. Real-time visualization tools allow users to explore the asset relationship map, as well as understand connection degrees and their implications for organizational security. The system's dynamic updates ensure current and relevant risk analyses.

In one example, the mitigation recommendations are generated based on asset connection and risk analysis. The system provides tailored strategies for specific asset configurations and risk profiles, helping organizations address vulnerabilities before escalation. The use of connections to monitor the network also applies to subjects like supply chain management and network infrastructure planning. By integrating connection information with cybersecurity practices, the system enhances organizational resilience against cyber threats.

### 4. Network Graph Examples

FIG. 3A illustrates an exemplary network graph in accordance with one or more embodiments. In the example of FIG. 3A, asset graph represents a comprehensive network infrastructure comprising diverse interconnected components. The graph includes assets, such as computers 302A, 302B, and 302C; wireless access points 304A, 304B, and phone 306; employees 306A and 306B (as human asset nodes interacting with multiple devices and software components); printer 308; network assets 310; workstation 312; software 320; operating systems, such as Windows OS 314 and Mac OS 316; video communication software 318; single sign-on (SSO) systems 322; lightweight directory access protocol (LDAP) services 324; structured query language (SQL) implementations 326; and databases.

FIG. 3B illustrates an exemplary network graph showing a risk analysis pathway 350 in accordance with one or more embodiments. The risk analysis pathway 350A is shown as a dotted pathway between computer 302C, workstation 312, computer 302B, wireless access point 304A, and network asset 310. In the example of FIG. 3B, the system determines that the number of connections of the risk analysis pathway 350A is four. Assuming that a security risk occurs at computer 302C (target asset), the system determines risk analysis pathway 350A and then makes recommendations for mitigation with respect to one or more of workstation 312, computer 302B wireless access point 304A, and network asset 310.

In an embodiment, recommendations are more extensive for assets closer to the target asset on the risk analysis pathway 350A. In one example, recommendations for workstation 312 are more extensive than recommendations for network asset 310 further away from computer 302C (the target asset) on the risk analysis pathway 350A.

In an alternate embodiment, a traversal score budget is used. A traversal score budget reduced as the risk analysis pathway 350A is increased. In one example, the traversal budget is 10, a link score between computer 302C and workstation 312 is 2, a link score between workstation 312 and computer 302B is 3, a link score between computer 302B and wireless access point 304A is 3, and a link score between wireless access point 304A and network asset 310 is 2. In this example, a link between computer 302C and workstation 312 reduces the traversal score to 8 from 10, a link between workstation 312 and computer 302B reduces the traversal score to 5 from 8, a link between computer 302B and wireless access point 304A reduces the traversal score to 2 from 5, and a link between wireless access point 304A and network asset 310 reduces the traversal score to 0 from 2.

In the example of FIG. 3B, only the single risk analysis pathway 350A is shown but, in one embodiment, multiple risk analysis pathways are created in different directions from computer 302C (target asset). The additional risk analysis pathways will have the number of connections or alternately use the traversal score budget method.

FIG. 3C illustrates an exemplary network graph showing a shortened risk analysis pathway 350B that terminates at an asset with a security profile that meets a pathway termination criteria in accordance with one or more embodiments. In the example of FIG. 3C, workstation 312 meets a pathway termination criteria, for example, due to security measures at workstation 312. The number of connections does not reach the maximum length of four, as shown for risk analysis pathway 350A of FIG. 3B, since workstation 312 meets the pathway termination criteria. In this case, the length of the shortened risk analysis pathway 350B is one. In the example of FIG. 3C, the system terminates risk analysis pathway 350B at workstation 312 since it is unlikely for a risk event to be spread by workstation 312 as indicated by the security profile. In this case, mitigation is not needed for computer 302B, wireless access point 304A, or network asset 310.

### 5. Practical Applications, Advantages, & Improvements

The risk propagation analysis system introduces significant efficiencies in computing device operations within network infrastructures. By optimizing the determination of risk analysis pathways, the system reduces computational overhead typically associated with exhaustive network scans. Computing devices benefit from streamlined processing of risk assessment data, enabling faster response times to emerging threats. The system's targeted approach to connection traversal minimizes unnecessary data processing, conserving CPU cycles and memory resources across network nodes. Efficient utilization of computing resources allows for more frequent and comprehensive risk analyses without impacting overall network performance. The system's ability to dynamically adjust the scope of risk analysis based on event severity and asset importance ensures optimal use of available computing power. Computational efficiencies extend to storage systems as the targeted nature of risk pathway analysis reduces the volume of log data generated and stored. Network devices experience reduced load from security-related traffic as the system focuses monitoring efforts on the most critical pathways. The intelligent distribution of risk analysis tasks across the network leverages the collective processing power of multiple devices, enhancing overall system responsiveness. These efficiencies culminate in a more agile and resource-conscious approach to network security, enabling organizations to maintain robust protection while optimizing the performance of their computing infrastructure.

### 5. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the embodiment, and what is intended by the applicants to be the scope of the embodiment, is the literal and equivalent scope of the set of claims that issue from this application, in the specific form in which such claims issue, including any subsequent correction.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

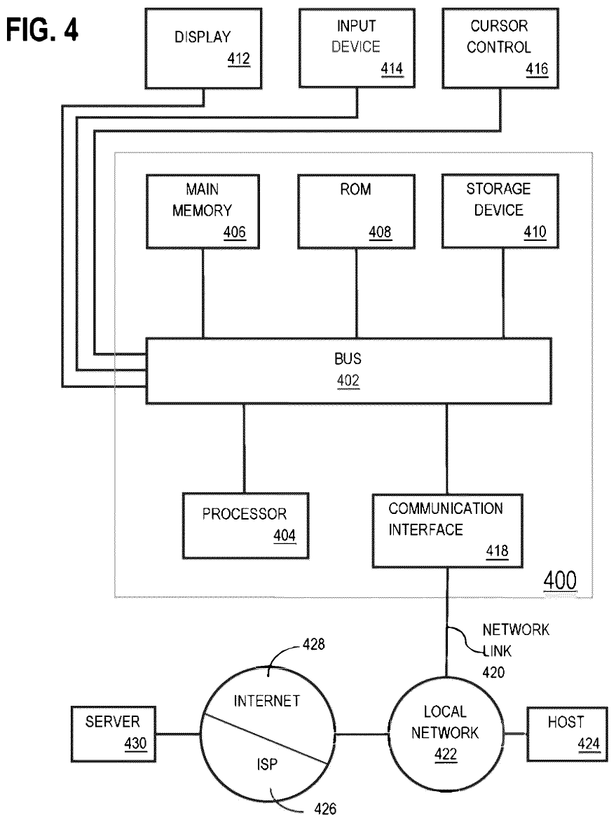

For example, FIG. 4 is a block diagram that illustrates a computer system 400 upon which an embodiment of the embodiment may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 440 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the embodiment have been described with reference to numerous specific details that may vary from implementation to implementation. The specification and drawings are, accordingly, to be regarded in an illustrative rather than a restrictive sense. The sole and exclusive indicator of the scope of the embodiment, and what is intended by the applicants to be the scope of the embodiment, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
generating a graph of assets in a network, including devices, software, and servers, wherein the graph defines connections between assets;
identifying a risk event with an associated risk severity;
determining a number of connections to traverse for generating a risk analysis pathway, through the graph of assets in the network, based on the associated risk severity associated with the risk event; and
generating at least one recommendation to address the identified risk event.

2. The non-transitory media of claim 1, further comprising:
determining a risk analysis pathway through at least some of the connections, wherein the risk analysis pathway indicates a possible vulnerability traversal through the network.

3. The non-transitory media of claim 2, wherein generating the at least one recommendation comprises identifying at least one asset, in the graph of assets, that is included in the risk analysis pathway for analysis corresponding to the risk event.

4. The non-transitory media of claim 1, further comprising:
determining a plurality of risk analysis pathways commencing at a target asset corresponding to the risk event wherein each of the plurality of risk analysis pathways traverses the number of connections.

5. The non-transitory media of claim 1, further comprising:
identifying a second risk event with a second associated risk severity, the second associated risk severity being greater than the associated risk severity;
determining a second number of connections to traverse for generating a second risk analysis pathway, the second number of connections being greater than the number of connections; and
generating a second set of recommendations to address the identified second risk event, wherein the second set of recommendations is more extensive than the at least one recommendation.

6. The non-transitory media of claim 1, further comprising dynamically updating the graph of the assets in the network as new assets are added to the network and as new connections between the assets are determined.

7. The non-transitory media of claim 1, wherein the generating the graph of assets in the network comprises monitoring communications between pairs of assets and generating links between the assets based on the communications between the pairs of assets.

8. The non-transitory media of claim 1, wherein the operations further comprise determining a second risk analysis pathway at least by:
selecting a maximum length for the second risk analysis pathway corresponding to the number of connections that is determined based on the associated risk severity;
commencing the second risk analysis pathway at a target asset, of the graph of assets, corresponding to the risk event; and
extending a length of the second risk analysis pathway from the target asset by traversing, from the target asset to additional assets in the graph of assets until either (a) the maximum length for the second risk analysis pathway is reached or (b) an asset is reached with a security profile that meets a pathway termination criteria.

9. The non-transitory media of claim 1, wherein the at least one recommendation includes a first mitigation strategy for a first asset on a risk analysis pathway, further comprising mitigating the risk event using the recommendation.

10. The non-transitory media of claim 9, wherein the at least one recommendation includes a second mitigation strategy for a second asset on a risk analysis pathway, wherein the second asset is further from the target asset on the risk analysis pathway than the first asset and wherein the second mitigation strategy is less substantial than the first mitigation strategy.

11. A non-transitory computer readable medium comprising instructions which, when executed by one or more hardware processors, causes performance of operations comprising:
identifying a risk event at a target asset with an associated risk severity;
assigning link scores to links between pairs of assets in an asset graph;
determining a traversal score budget for traversing an asset graph from a target asset based on the associated risk severity;
extending risk analysis pathways starting at the target asset based on the traversal score budget by:
for a first risk analysis pathway of the risk analysis pathways, initiating a traversal score with the traversal score budget;
traversing links while decreasing the traversal score with a link score for the link to create a remaining traversal score; and
terminating the first risk analysis pathway when the remaining traversal score is zero or less than a link score of the link scores for a next link to be traversed; and
generating at least one recommendation to address the identified risk event.

12. The non-transitory media of claim 11, wherein the link scores are based on interactions and dependencies between the assets.

13. The non-transitory media of claim 11, wherein generating the at least one recommendation comprises identifying at least one asset, in the graph of assets, that is included in the first risk analysis pathway for analysis corresponding to the risk event.

14. A system comprising:
at least one device including a hardware processor;
the system being configured to perform operations comprising:
generating a graph of assets in a network, including devices, software, and servers, wherein the graph defines connections between assets;
identifying a risk event with an associated risk severity;
determining a number of connections to traverse for generating a risk analysis pathway, through the graph of assets in the network, based on the associated risk severity associated with the risk event; and
generating at least one recommendation to address the identified risk event.

15. The system of claim 14, further comprising:
determining a risk analysis pathway through at least some of the connections, wherein the risk analysis pathway indicates a possible vulnerability traversal through the network.

16. The system of claim 15, wherein generating the at least one recommendation comprises identifying at least one asset, in the graph of assets, that is included in the risk analysis pathway for analysis corresponding to the risk event.

17. The system of claim 14, further comprising:
determining a plurality of risk analysis pathways commencing at a target asset corresponding to the risk event wherein each of the plurality of risk analysis pathways traverses the number of connections.

18. The system of claim 14, further comprising:
identifying a second risk event with a second associated risk severity, the second associated risk severity being greater than the associated risk severity;
determining a second number of connections to traverse for generating a second risk analysis pathway, the second number of connections being greater than the number of connections; and
generating a second set of recommendations to address the identified second risk event, wherein the second set of recommendations is more extensive than the at least one recommendation.

19. The system of claim 14, further comprising dynamically updating the graph of the assets in the network as new assets are added to the network and as new connections between the assets are determined.

20. The system of claim 14, wherein the generating the graph of assets in the network comprises monitoring communications between pairs of assets and generating links between the assets based on the communications between the pairs of assets.
